(19) United States
(12) Patent Application Publication
(10) Pub. No.: US 2009/0297049 A1
(43) Pub. Date: Dec. 3, 2009

(54) DETECTION OF PARTIALLY OCCLUDED TARGETS IN LADAR IMAGES

(75) Inventors: Haim Garten Garten, Haifa (IL); Meir Barzohar, Haifa (IL); Yoram Swirski, Kiryat Bialik (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: RAFAEL ADVANCED DEFENSE SYSTEMS LTD., Haifa (IL)

(21) Appl. No.: 11/994,852

(22) PCT Filed: Jul. 9, 2006
(86) PCT No.: PCT/IL06/00792

§ 371 Date: Jul. 22, 2008

(30) Foreign Application Priority Data
Jul. 7, 2005 (IL) 169588

(51) Int. Cl. G06K 9/62

(52) U.S. Cl. 382/225

(57) ABSTRACT

A method for detection the presence of a man-made object partially occluded in a natural environment. The method includes the steps of providing an image segment from three dimensional ladar data, grouping one or more coplanar portion of the pixels into a cluster of planar sections, each planar section including three or more pixels, classifying the cluster based on one or more criterion selected from a group of criteria.

### FIELD AND BACKGROUND OF THE INVENTION

The present invention relates to processing of ladar data and particularly to detecting partially obscured objects, such as a tuck camouflaged by trees.

Lidar or Ladar—Laser Imaging Detection and Ranging is a technology that determines distance to an object or surface using laser pulses. Like radar technology, which uses radio waves instead of light, the range to an object is determined by measuring the time delay between transmission of a pulse and detection of the reflected signal.

A basic ladar scanning system 10 is illustrated schematically in FIG. 1a (prior art). Ladar system 10 includes a pulse generator 105 driving a pulsed laser transmitter 101. Laser pulses travel toward target 113. Target 113 backscatters a small amount of the light of each pulse back in the direction of ladar scanning system 10. An optical receiver 103 detects the backscattered light and amplifies the pulsed signal using an electronic amplifier 107. A control and logic block 109 controls the timing of the transmitted and received pulses and measures time of flight (TOF) of the pulses.

Reference is now made also to FIG. 1b (prior art) which includes a simplified graph of time of flight (abscissa) with intensity (ordinate) both on relative scale. Control and logic block 109 controls the timing of the transmission of a transmit pulse 102 and determines the times of receiving pulses 104 and 106 due to back scatter from target 113. Received pulse 104 is the first echo backscattered from a region of target 113 that is closest to ladar system 10. Last echo 106 is a measurement of light backscattered from a further region from ladar system 10 and therefore, the time of flight between the transmission of transmit pulse 102 and the reception of last echo 106 is greater than that of first echo 104.

Ladar systems are of continuing interest in the areas of terrestrial mapping, defense, public safety, law enforcement, and the war against tenor. Typically, vehicles or other large man-made objects are camouflaged or otherwise hidden in bush or foliage. It is of interest to the public welfare to have a ladar system which uses an algorithm for processing ladar image data to enable visualizing or otherwise detecting the hidden objects.

Patent application WO 2005/004052 entitled “Method and Apparatus for Automatic so Registration and Visualization of Occluded Targets using Ladar Data”, discloses collecting multiple frames of ladar image data from two or more points of view, registering the data frames forming a unified image based on the data from multiple frames. The disclosure of WO 2005/004052 is directed towards visualization of occluded targets and as such requires human intervention where the output of image processing is fed back to an operator whose goal is to detect and identify the occluded objects.

Thus there is a need for and it would be very advantageous to have a method for detection of occluded targets using an analytic classification method. The detection of occluded targets is a useful input to other systems without requiring human intervention or visualization by machines.

### SUMMARY OF THE INVENTION

According to the present invention, there is provided a method for detecting the presence of a man-made object partially occluded if present in a natural environment. An image segment is provided from three dimensional ladar data. The segment includes pixels representing a three dimensional region including the object. In each segment, coplanar pixels are grouped into clusters of planar sections where each planar section includes three pixels or more pixels. The segments are classified based on criteria such as:

(i) an area of one or more planar sections, and ii) a ratio between the number of pixels included in the segment to the total number of planar sections. Preferably, the ground level and missing data are estimated in the natural environment using solely the LADAR data, prior to grouping the clusters. Preferably, the grouping of the clusters is based on intersecting planar sections. Preferably providing the image segment includes clipping the ladar data based on the height of said pixels from the ground and the clipping refers to a ground surface estimation based on said ladar data. Preferably, the ladar data is filtered according to last echo.

According to the present invention there is provided a system for classifying a partially occluded object. The system includes an input mechanism which receives ladar data including pixels representing a segment of three dimensional space including the object, a storage mechanism, connected to the input mechanism, which stores the ladar data in memory and a processing mechanism, connected to the storage mechanism. The processing mechanism groups one or more coplanar portions of the pixels into a cluster of planar sections, each planar section including three or more pixels; and classifies the cluster based on criteria such as an area of at least one of said planar sections, and a ratio between the number of pixels included in the segment to the total number of planar sections included in the segment. Preferably, the processing mechanism further groups the pixels based on the planar sections intersecting, and clips the ladar data based on height of the pixels from the ground. Preferably, the processing mechanism refers to a ground surface estimation based on the ladar data and the processing mechanism filters the ladar data according to last echo.

According to the present invention there is provided, a program storage device readable by a machine, tangibly embodying a program of instructions executable by the machine to perform a method for classifying and thereby detecting the presence of a man-made object at least partially occluded in a natural environment, the method as describe herein.

### BRIEF DESCRIPTION OF TIM DRAWINGS

The invention is herein described by way of example only, with reference to the accompanying drawings, wherein:

FIG. 1 (prior art) is a simplified drawing of a ladar system;

FIG. 2 is a simplified flow diagram of processing ladar data, according to an embodiment of the present invention;

FIG. 3 illustrates three dimensional ladar data with use of last echo only and height clipping, according to an embodiment of the present invention;

FIG. 4 illustrates the step of planar modeling in three dimensional ladar data, according to an embodiment of the present invention;

FIG. 5 illustrates the planes derived for two different image segments, in three dimensional ladar data, according to an embodiment of the present invention;

FIG. 6 is a graph illustrating a weight function of two features used to classify ladar data, according to an embodiment of the present invention;

FIG. 7 is a histogram of segments marks classified according to an embodiment of the present invention. Target segments show a notably higher “marks” than non targets segments;

FIG. 8a is a simplified flow diagram of pre-processing and segmentation of ladar data, according to an embodiment of the present invention;

FIG. 8b is a simplified flow diagram of planar modeling and classification of segments, according to an embodiment of the present invention; and

FIG. 9 is a simplified diagram of a computerized device which processes ladar data and displays a target according to an embodiment of the present invention.

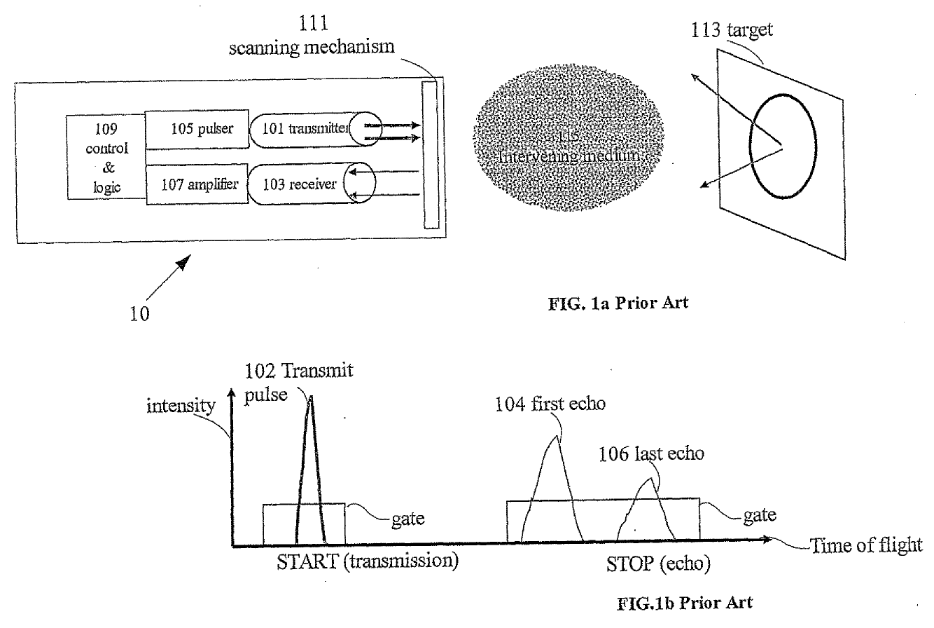

### DESCRIPTION OF THE PREFERRED EMBODIMENTS

The present invention is of a method and system for classifying a partially occluded object in tree dimensional ladar data.

The principles and operation of detecting a partially occluded objet, according to the present invention may be better understood with reference to the drawings and file accompanying description.

Before explaining embodiments of the invention in details, it is to be understood that the invention is not limited in its application to the design details and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

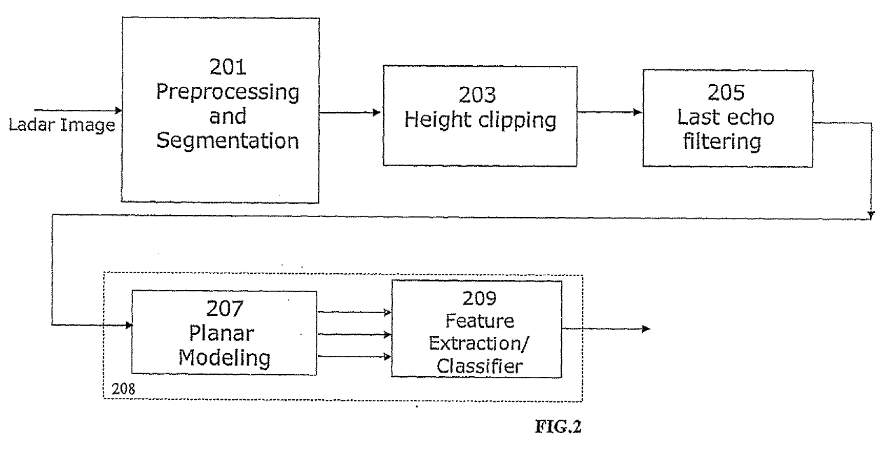

Referring now to the drawings, FIG. 2 is a simplified block diagram of the process for detecting man-made objects in three dimensional ladar data. By way of introduction, the process begins with ladar image data typically of natural settings, e.g. forest. A primary intention of the present invention is to process the three dimensional data, preferably automatically, using computerized techniques to distinguish and detect partially occluded objects, typically large man-made objects, e.g. a truck. The process includes pre-processing and segmentation 201 of the three dimensional data, in which the tee dimensional ladar data is partitioned into segments followed by height threshold clipping 203, last echo filtering 205, planar modeling 207, feature extraction and classification 209.

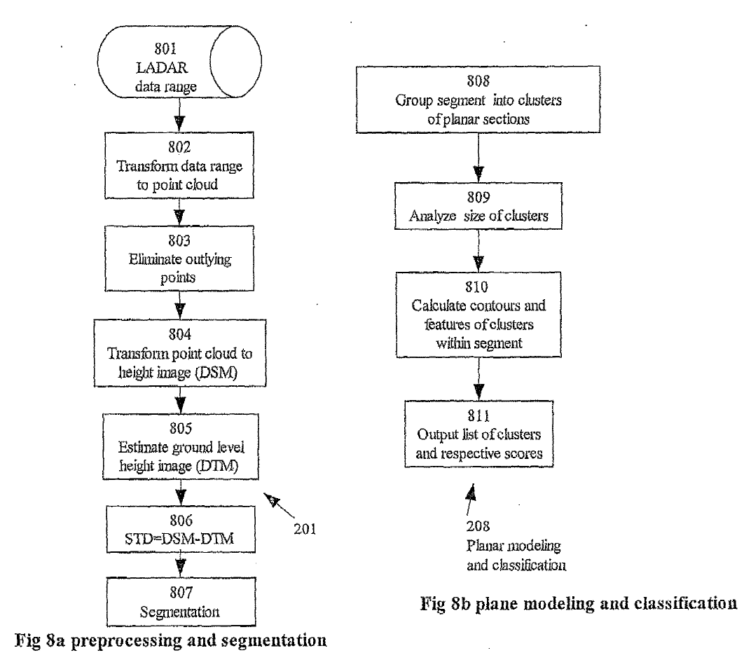

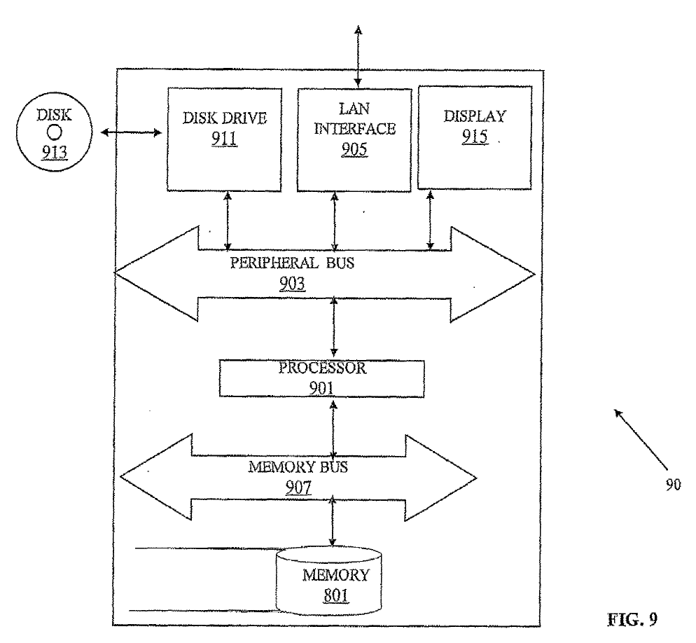

FIG. 8a is a simplified block diagram of pre-processing and segmentation process 201. Ladar data is input from storage 801. Prior to segmentation (step 807), preprocessing (steps 802-806) of input ladar data is performed. In step 802, a data range of raw LADAR data is transformed into a three dimensional point cloud. Raw data typically includes a range, sensor location and line-of-sight angles. In step 803, outlying points eliminated including points far from real surfaces that may be caused by cables, flying birds or sensor errors. In step 804, the three dimensional point cloud is converted to a height image referenced to the ground using a digital surface model (DSM) at a pre-determined spatial resolution (e.g. 0.5 m×0.5 m) on the ground. Given an image with a fixed resolution, well known tools known in the art of image processing may be applied to improve the image. During re-sampling (step 804) of the three dimensional point-cloud to a height-image, several tree dimensional points 370 are typically located within a given pixel (as in a vertical plane). The same situation occurs in the presence of partial obscuration, of a target where the target is located under a tree and is visible in slant LOS (Line Of Sight) or as “last echo”. According to an embodiment of the present invention, an “average” height value for points inside a square of 0.5×0.5 meter in the X,Y domain, is:

$$\overline{z} = {[ \frac{1}{N} {\sum }_{i = 1}^{N} {z}_{i}^{α} ]}^{1 / α} \qquad ( 1 )$$

where Zᵢ (i=1 . . . N) are the height of the points and a determines the weights: negative favors minimum, positive favors maximum and 1 is a simple mean.

Typically, the ground level height image is estimated (step 305) using a digital terrain model (DTM) The surface terrain difference (STD) for each XY point is the height difference (step 806) between the terrain heights as determined using the digital terrain model and surface heights from for instance buildings and vegetation using a digital surface model (DSM).

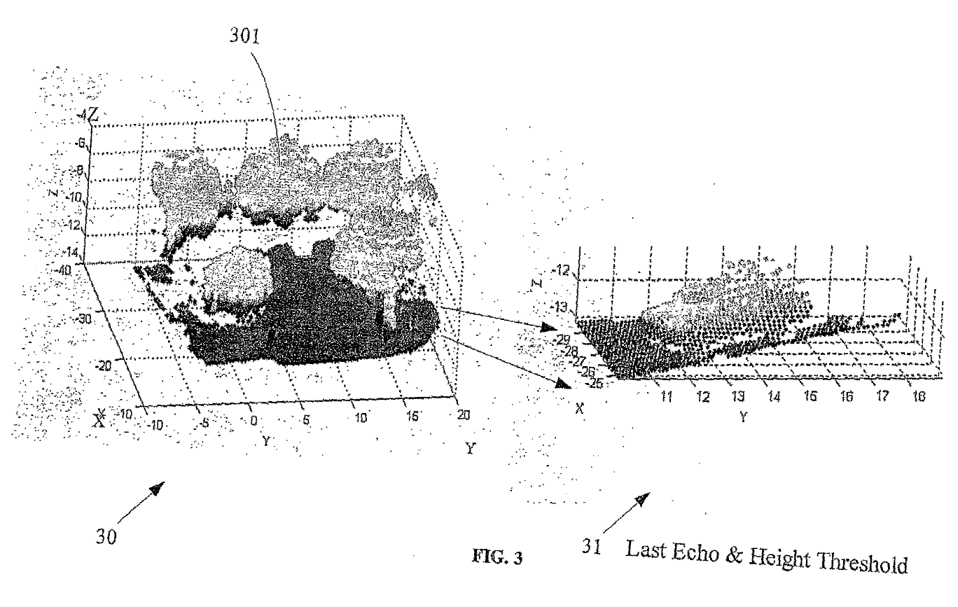

FIG. 3 illustrates a three dimensional image 30 of a region including trees and underlying foliage. Tree tops 301 are clearly visible. Segmentation 807 is performed by grouping points which are above a certain height threshold above estimated ground level. The elevation of the ground is estimated from the ladar data, for instance by using the lowest height value in a segment or using a sliding function based on the lowest height value moving horizontally across the height image. In the ground level estimating process, regions of missing data (e.g. occluded by tall objects) are filled using an interpolation method. Another height threshold is chosen, (e.g. 5 meters). Image points higher than the height threshold are clipped (step 203), i.e. removed from the image.

Multiple echoes, e.g. first echo 104 and last echo 106 may be detected if the light is partially reflected from occluding objects (such as leaves) with a target underneath. For aerial ladar imaging in the direction of the ground, such as in image segment 31, the data is filtered to include only last echoes 106 in which last echo filtering (step 205) preferentially provides information regarding objects near the ground. A processed three dimensional image segment 31 is shown in FIG. 3 (right side) subsequent to height threshold clipping (step 203) and last echo filtering (step 205).

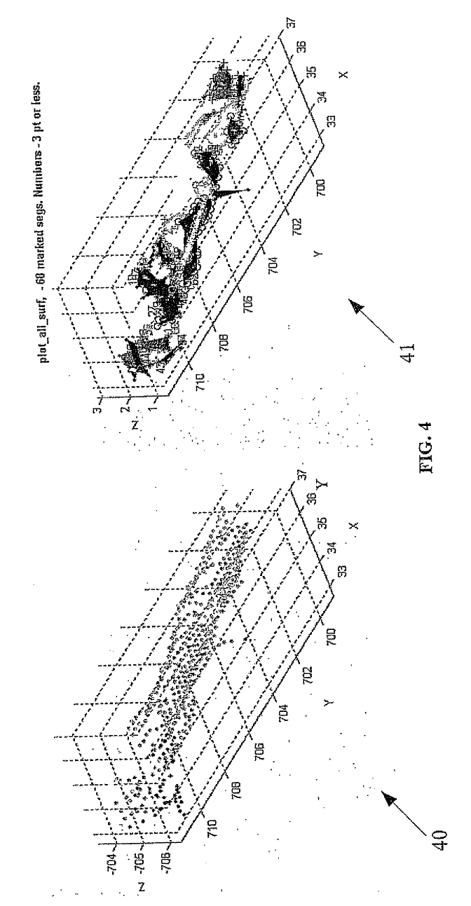

Reference is now made to FIG. 4 which illustrates planar modeling (step 207). Image segment 40 is shown. Reference is also made to flow diagrams in FIG. 8b and FIG. 2. Planar modeling (step 207) of image segment 40 is performed by grouping (step 808) image points into planar sections, each planar section including a number (greater than three) of co-planar points of image segment 40. Planar sections of image segment 40 are shown in planar model 41 of image segment 40. Preferably, planar sections contained in image segment 40 are classified (step 809) by size, e.g. area of the largest plane and the average number of points within the planar sections. These two features are used later for classification if a man made object has been detected. In planar modeling, segment 40 is modeled as a group or cluster of planar sections where each planar section is defined by three or more points in a plane.

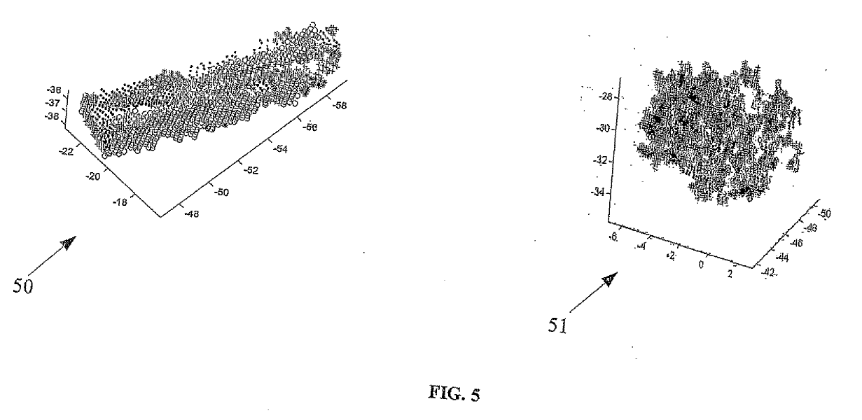

FIG. 5 illustrates similar planar models of a launcher 50 and a tree 51. Planar model 51 of the tree includes a larger number of planes and smaller planes than plan model 50 of the launcher.

Feature extraction and classification 209, according to an embodiment of the present invention is performed by considering the two features:

(i) the area of typically the largest planar section (e.g. of planar model 41) or in a cluster of planar sections (e.g. within planar model 41), and

(ii) the ratio between the number of pixels included in image segment 40 to the number of planar sections included in planar model 41, namely the average number of points per plane.

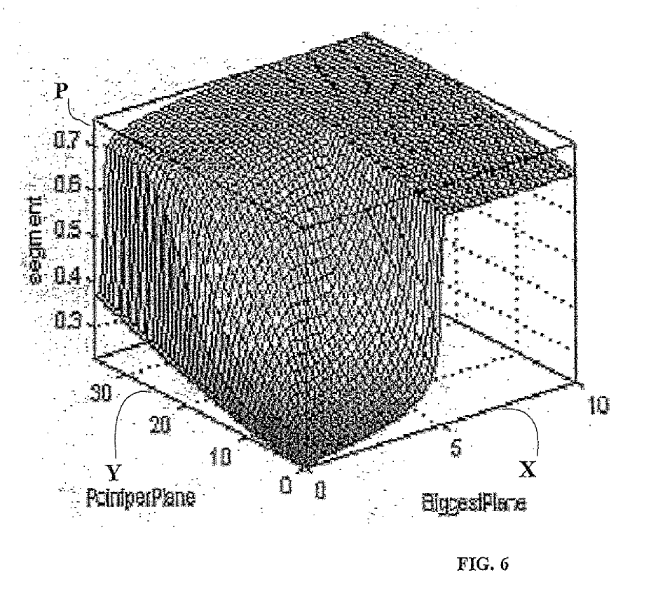

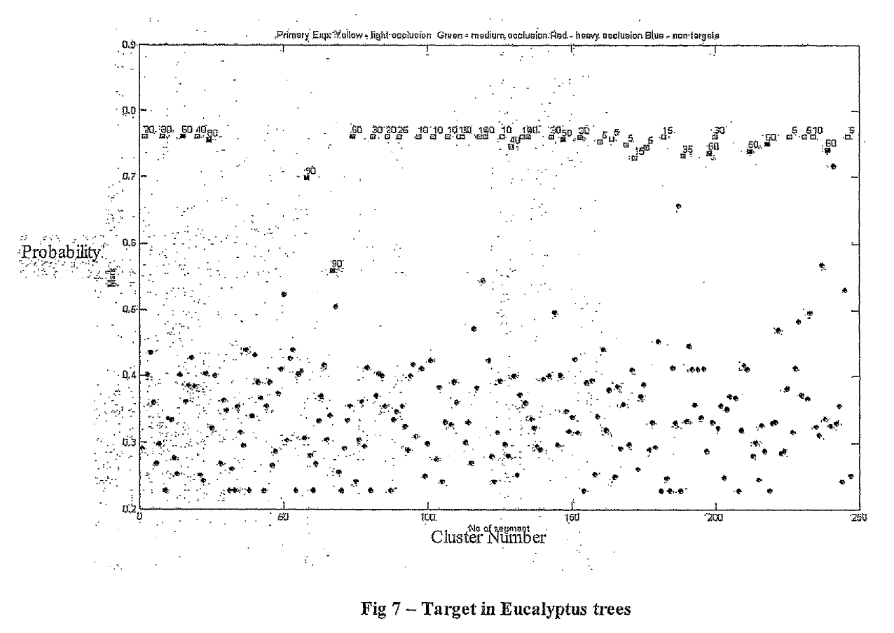

These two features are used to classify (step 810) image segment 31 if it is a target of interest and output a score (step 811) of a segment or cluster of planar sections indicating a probability of being a target. Referring now to FIG. 6, a weight function is graphed as an independent function of the two features. The weight increases when either the largest planar section becomes large or when the ratio of the number of pixels/number of planes increases.

Process 208 as described above, according to an embodiment of the present invention, was performed with LADAR data, e.g. a target partially occluded under eucalyptus trees. A histogram shows the scores of each image segment as classified based on the above criteria. The histogram clearly shows two groups of scores: Values greater than about 0.7 were classified (and in fact were) as an occluded target. The lower group of marks is assumed to be segments of natural clutter.

The algorithm, according the present invention, is preferably performed using a computer 90, which includes a processor 901, a storage mechanism including a memory bus 907 to store information in memory 801 a LAN interface 905, to receive ladar image data each operatively connected to processor 901 with a peripheral bus 903. Computer 90 her includes a programming input mechanism 911, e.g. disk drive from a program storage device 913, e.g. optical disk. Programming input mechanism 911 is operatively connected to processor 901 with a peripheral bus 903.

While the invention has been described with respect to a limited number of embodiments, it will be appreciated that many variations, modifications and other applications of the invention may be made.

What is claimed is:

1. A method for detection the presence of a man-made object at least partially occluded in a natural environment the method comprising the steps of:
(a) providing an image segment from three dimensional ladar data, said segment including a plurality of pixels representing a three dimensional region including the object;
(b) grouping at least one coplanar portion of said pixels into a cluster of planar sections, each planar section including at least three said pixels; and
(c) classing said cluster based on at least one criterion selected from the group of criteria consisting of:
(i) an area of at least one of said planar sections, and
(ii) a ratio between the number of pixels included in said segment to the total number of planar sections included in said segment.

2. The method, according to claim 1, further comprising the step of, prior to said grouping:
(d) estimating ground level in the natural environment using solely said LADAR data.

3. The method, according to claim 1, further comprising the step of, prior to said grouping:
(d) estimating missing data using solely said LADAR data.

4. The method, according to claim 1, wherein said grouping includes clustering based on said planar sections intersecting.

2. The method, according to claim 1, wherein said providing includes clipping the ladar data based on the height of said pixels from the ground.

3. The method, according to claim 2, wherein said clipping refers to a ground surface estimation based on said ladar data.

4. The methods according to claim 1, further comprising the step of:
(d) filtering said ladar data according to last echo.

5. A system for classifying a partially occluded object, the system comprising:
(a) an input mechanism which receives ladar data including a plurality of pixels representing a segment of three dimensional space including the object;
(b) a storage mechanism which stores said ladar data in memory, said storage mechanism operatively connected to the input mechanism
(c) a processing mechanism, operatively connected to the storage mechanism which:
(i) groups at least one coplanar portion of said pixels into a cluster of planar sections, each planar section including at least three said pixels; and
(ii) classifies said cluster based on at least one criterion selected from the group of criteria consisting of:
(A) an area of at least one of said planar sections; and
(B) a ratio between the number of pixels included in said segment to the total number of planar sections included in said segment.

6. The system, according to claim 8, wherein said processing mechanism further groups said pixels based on said planar sections intersecting.

7. The system, according to claim 8, wherein said processing mechanism fierier clips the ladar data based on height of said pixels from the ground.

8. The system, according to claim 7, wherein said processing mechanism refers to a ground surface estimation based on said ladar data.

9. The system, according to claim 8, wherein said processing mechanism further filters said ladar data according to last echo.

10. A program storage device readable by a machine, tangibly embodying a program of instructions executable by the machine to perform a method for classifying and thereby detecting the presence of a man-made object at least partially occluded in a natural environment the method comprising the steps of:
(a) providing an image segment from three dimensional ladar data, said segment including a plurality of pixels representing a three dimensional region including the object;
(b) grouping at least one coplanar portion of said pixels into a cluster of planar sections, each planar section including at least three said pixels; and
(c) classifying said cluster based on at least one criterion selected from the group of criteria consisting of:
(i) an area of at least one of said planar sections, and
(ii) a ratio between the number of pixels included in said segment to the total number of planar sections included in said segment.
